(19) United States
(12) Patent Application Publication
(10) Pub. No.: US 2020/0149552 A1
(43) Pub. Date: May 14, 2020

(54) BLOWER MOTOR ASSEMBLY BALANCING ACHIEVED THROUGH THIN PROFILE ADHESIVE BACKED COUNTERWEIGHTS STRIPS

(71) Applicant: Hanon Systems, Daejeon (KR)

(72) Inventors: Ted Vanden Berg, Canton, MI (US); David Miller, Livonia, MI (US)

(21) Appl. No.: 16/190,338

(22) Filed: Nov. 14, 2018

(51) Int. Cl. F04D 29/66; F04D 29/28; F16F 15/34

(52) U.S. Cl. CPC F04D 29/662; F04D 29/281; F05D 2260/96; F05D 2240/20; F05D 2260/15; F16F 15/34

(57) ABSTRACT

A blower wheel for a blower motor assembly includes a plurality of annularly arranged blades and an annular structure coupled to each of the blades. A counterweight including a base layer having an adhesive coated thereon is adhered to the blower wheel to correct an imbalance of the blower wheel relative to an axis of rotation of the blower wheel. A method of balancing the blower wheel is also disclosed, wherein the method includes the steps of determining an imbalance of the blower wheel relative to a rotational axis thereof and adhering a counterweight to the blower wheel to correct the imbalance of the blower wheel.

### FIELD OF THE INVENTION

The invention relates to a blower motor assembly, and more particularly, to a blower wheel of the blower motor assembly having at least one adhesive backed counterweight coupled thereto for correcting an imbalance of the blower wheel relative to an axis of rotation thereof.

### BACKGROUND OF THE INVENTION

Centrifugal blowers are commonly used for directing a forced flow of air through an air duct. In a typical blower motor assembly, air is drawn into a housing through an air inlet and discharged from the housing through an air outlet. The blower motor assembly typically includes an electrically driven blower wheel that rotates in a predetermined direction in the housing. The blower wheel includes one or more arcuate blades disposed around a periphery thereof. The blower wheel is configured to draw the air into the air inlet of the housing in a direction parallel to an axis of rotation of the blower wheel before discharging the air from the air outlet of the housing while flowing in a tangential direction of the blower wheel arranged perpendicular to the axis of rotation thereof.

An imbalance of the blower wheel can lead to an eccentric path for a center of mass of the blower wheel when rotating about the axis of rotation thereof. This imbalance can lead to an undesirable vibration of the blower wheel that can potentially propagate to the passenger compartment of the vehicle. Additionally, such vibration may shorten a life of the components of the blower motor assembly due to the continuous and repeated contact therebetween as a result of the oscillating of the blower wheel relative to the housing.

In order to reduce such an imbalanced rotation, it is common for the blower wheel of such a blower motor assembly to be subjected to a balancing process. The balancing process includes the altering of the distribution of mass of the blower wheel relative to the axis of rotation thereof in order to minimize a distance between a center of mass of the blower wheel and the axis of rotation thereof. The balancing of the blower wheel is typically performed with respect to at least two different planes arranged perpendicular to the axis of rotation of the blower wheel, wherein the balancing process is most accurate and efficient when the two different planes are separated by a maximum distance with respect to the axial direction of the blower wheel. However, in some circumstances the balancing process may be performed with respect to a single plane arranged perpendicular to the axis of rotation of the blower wheel, as desired.

One common method for redistributing the mass of the blower wheel includes the installation of one or more counterweight clips to one or more edges of the blower wheel before again testing the balance of the blower wheel relative to the remainder of the blower motor assembly. The clips may be formed from a metallic material and may include two leg portions depending from a bent portion, wherein the two leg portions are inwardly deformed toward opposing surfaces of the blower wheel while the bent portion is placed in abutment with the corresponding edge of the blower wheel. The clips may typically be placed on an edge of one of the blades disposed about the periphery of the blower wheel, with the two leg portions straddling the opposing surfaces of the corresponding blade. In some embodiments, each of the counterweight clips may further include inwardly extending barbs for penetrating the outer surface of a corresponding one of the blades in order to affix a position of each of the clips relative to the corresponding one of the blades.

However, the use of the deformable clips results in an undesirably complex and inefficient balancing process with respect to the blower wheel for a variety of reasons. First, the clips themselves must be manufactured to include a complex shape and configuration for coupling to the blades of the blower wheel. It may be necessary to produce the clips in a complex stamping operation, for example, in order to form any complex features such as the aforementioned barbs used to maintain the coupled position of each of the clips. The predetermined configuration of each of the clips required when using the repetitive stamping process results in the clips being formed at predetermined and stepped sizes and hence mass values. The use of stepped mass values often leads to the need for a plurality of the clips to be coupled to the blower wheel to achieve the desired distribution of mass, thereby increasing the number of clip installations required for carrying out each of the iterations of the balancing process. Furthermore, the stepped mass values may also lead to the need for more iterations of the balancing process to achieve the desired distribution of mass of the blower wheel.

Secondly, it has been found that the installation of such clips is best performed by a skilled operator rather than by automated means such as the use of a robotic apparatus. The skilled operator typically utilizes a set of pliers to grip, transport, and eventually deform each of the clips to the corresponding blades of the corresponding feature of the blower wheel. The use of a skilled operator may be prohibitively expensive while also introducing potential inconsistencies in the installation process. The use of the pliers also limits the suitable locations for applying the clips, as it has been discovered that placing the clips on the inner edges of the blades adjacent the hub of the blower motor assembly is prohibitively difficult due to the manner in which the hub typically projects axially towards the skilled operator at the intersection of the hub and each of the blades, thereby obstructing a pathway for the pliers to reach the desired location at the desired orientation. It has also been discovered that the installation of such clips on the outer edges of the blades is also undesirable, as the clips may be dislodged from the exposed outer edges of the blades during handling and installation of the blower wheel. The clips are accordingly often limited to positions on the inner edges of the blades and spaced from the hub thereof, which in turn limits the axial distance between the two or more planes tested for the imbalance during the balancing process to limit the effectiveness and efficiency of the balancing process. Lastly, the use of clips having complex structural features such as retaining barbs may undesirably lead to a circumstance wherein the clips cannot be removed or repositioned on the blower wheel without potentially causing damage to the corresponding blades.

Accordingly, it would be desirable to produce an improved counterweight structure for correcting the imbalance of a blower wheel in a timely and efficient manner.

### SUMMARY OF THE INVENTION

Compatible and attuned with the present invention, an improved counterweight structure and a method of using the same has been surprisingly discovered.

In one embodiment of the invention, a blower wheel for a blower motor assembly includes a plurality of annularly arranged blades and an annular structure coupled to each of the blades. A counterweight is adhered to the blower wheel. The counterweight includes a base layer having an adhesive coated thereon. The counterweight is configured to correct an imbalance of the blower wheel relative to an axis of rotation of the blower wheel.

According to another embodiment of the invention, a method of balancing a blower wheel of a blower motor assembly is disclosed. The method comprising the steps of determining an imbalance of the blower wheel relative to a rotational axis thereof and adhering a counterweight to the blower wheel to correct the imbalance of the blower wheel.

### BRIEF DESCRIPTION OF THE DRAWINGS

The above, as well as other objects and advantages of the invention, will become readily apparent to those skilled in the art from reading the following detailed description of a preferred embodiment of the invention when considered in the light of the accompanying drawings:

FIG. 1 is perspective view of blower motor assembly according to an embodiment of the present invention;

FIG. 2 is a top plan view of the blower motor assembly;

FIG. 3 is a cross-sectional elevational view of the blower motor assembly as taken through section lines 3-3 of FIG. 2;

FIG. 4 is an elevational view showing a counterweight removed from a strip of material formed into a roll;

FIG. 5 is an enlarged fragmentary elevational view of a portion of the counterweight of FIG. 4;

FIG. 6 is a perspective view of the counterweight of FIG. 4;

FIG. 7 is a top plan view of a simplified blower wheel illustrating a first example of a balancing process used to correct an imbalance of the blower wheel;

FIG. 8 is a top plan view of a simplified blower wheel illustrating a second example of a balancing process used to correct an imbalance of the blower wheel; and

FIG. 9 is a top plan view of a simplified blower wheel illustrating a third example of a balancing process used to correct an imbalance of the blower wheel.

### DETAILED DESCRIPTION OF THE INVENTION

The following detailed description and appended drawings describe and illustrate various embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

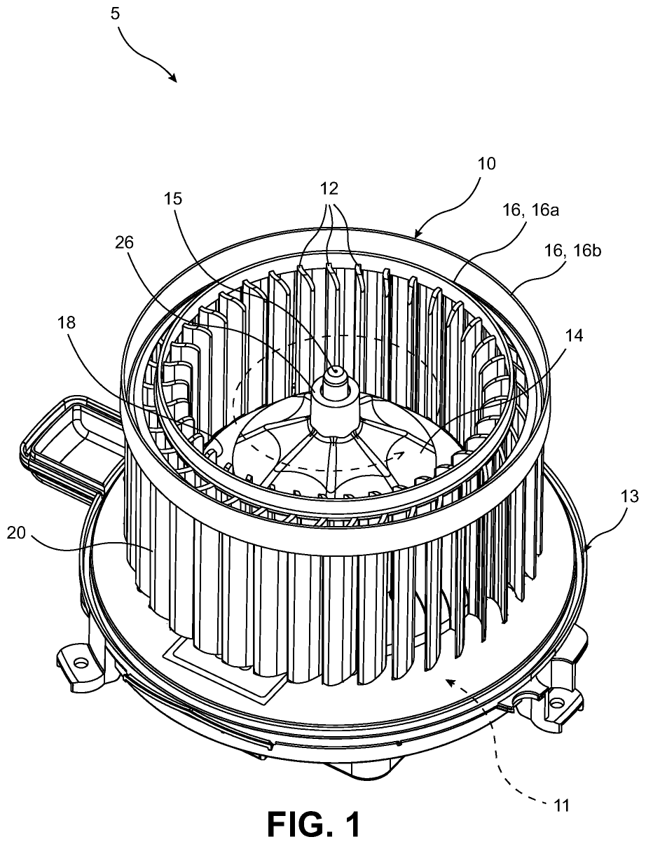

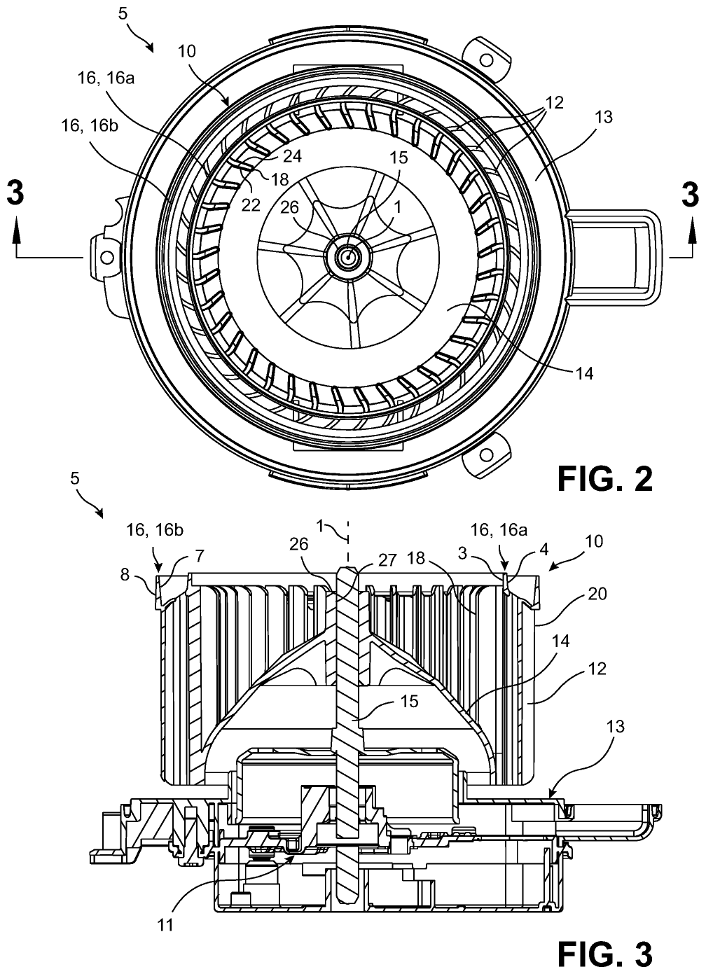

FIGS. 1-3 illustrate a blower motor assembly 5 according to the present invention. The blower motor assembly 5 generally comprises a blower wheel 10 and a blower motor 11. The blower motor 11 comprises a motor housing 13 and a rotor 15 driven by a driving mechanism of the blower motor 11. In the provided embodiment, the driving mechanism is an electrically powered motor, but it should be understood that any suitable mechanism for providing rotational motion about an axis of rotation may be used without necessarily departing from the scope of the present invention. The blower motor assembly 5 may be used for any application such as the blowing of air through an air conditioning unit of a vehicle, for example.

Typically, the blower motor assembly 5 is disposed within a housing (not shown) such as that described in U.S. Pat. No. 8,382,563 to Sievers et al., which is incorporated herein by reference in its entirety. It is understood, however, that the blower motor assembly 5 can be incorporated into any housing structure for causing the blowing of air without departing from the scope of the present invention. A rotational movement of the blower wheel 10 in a first rotational direction (shown in FIG. 1) causes a flow of air received in an air inlet of the housing to flow at an increased dynamic pressure in a radially outward direction in respect of the blower wheel 10.

As illustrated, the blower wheel 10 includes an annular array of spaced apart blades 12 extending between a hub 14 and at least one concentrically arranged ring 16. The hub 14 forms an annularly extending structure for connecting to a first end of each of the blades 12 while the at least one ring 16 forms an annularly extending structure for connecting to a second end of each of the blades 12. In the illustrated embodiment, the at least one ring 16 includes a first ring 16a and a second ring 16b, but any configuration of the rings 16 may be used without departing from the scope of the present invention. As best shown in FIG. 3, the first ring 16a includes an inner circumferential surface 3 and an oppositely outer circumferential surface 4 while the second ring 16b includes an inner circumferential surface 7 and an oppositely arranged outer circumferential surface 8.

In certain embodiments, the blades 12 are arranged on an outer periphery of the hub 14 at equal intervals with respect to an axis of rotation 1 of the blower wheel 10, although other intervals can be used, as desired. Additional or fewer blades 12 than shown can be employed, as desired.

Each of the blades 12 includes a leading edge 18 and a trailing edge 20 extending in a height direction of the blower wheel 10. The leading edge 18 is directed substantially radially inwardly in a direction towards the axis of rotation of the blower wheel 10 while the trailing edge 20 is directed substantially radially outwardly in a direction away from the axis of rotation. The leading edge 18 forms the first surface of each of the blades 12 to encounter the flow of air traveling radially outwardly through the blower wheel 10 while the trailing edge 20 forms the last surface of each of the blades 12 to encounter the flow of air.

Each of the blades 12 further includes a first surface 22 and an oppositely arranged second surface 24. In certain embodiments, the first surface 22 has a substantially convex shape facing in the direction of rotation of the blower wheel 10 and the second surface 24 has a substantially concave shape facing away from the direction of rotation of the blower wheel 10. The first surface 22 may accordingly form a leading surface of each of the blades 12 for pushing the flow of air during rotation of the blower wheel 10 while the oppositely arranged second surface 24 forms a trailing surface of each of the blades 12. It is understood that the first surface 22 and the second surface 24 can have any shape as desired, such as a substantially concave shape in the direction of rotation of the blower wheel 10, a substantially convex shape in the direction of rotation of the blower wheel 10, or a substantially planar shape, as non-limiting examples. It is further understood that the first surface 22 and the second surface 24 may include a shape with a combination of at least one concave surface and at least one convex surface, as desired.

The hub 14 may be generally dome-shaped and may include a nose portion 26 formed at an apex thereof. The nose portion 26 may include a central opening 27 configured for operatively engaging the rotor 15 of the blower motor 12 in a manner wherein the rotational motion of the rotor 15 is transferred to the blower wheel 10. The rotor 15 and the central opening 27 may have corresponding structure for transferring the motion therebetween, such as corresponding splined surfaces, for example. A central axis of the rotor 15 defines the axis of rotation 1 of the blower wheel 10 when the blower wheel 10 is operatively coupled to the blower motor 11. In other embodiments, the nose portion 26 may alternatively include a shaft or projection (not shown) configured for operatively and rotatably engaging a bushing (not shown) of the blower motor 12, wherein the shaft or projection of the blower wheel 10 defines the axis of rotation thereof. It should be understood that any structure suitable for rotatably coupling the blower wheel 10 to a corresponding blower motor 12 while defining an axis of rotation of the blower wheel 10 may be used without departing from the scope of the present invention. An outer surface of the hub 14 may include a wave configuration formed from an annular array of crests and an annular array of troughs alternately formed in the outer surface of the hub 14, wherein the wave configuration strengthens the hub 14 while also avoiding the introduction of resonant frequencies within the blower wheel 10.

The blower wheel 10 may be formed from any suitable material and may be formed in any suitable manufacturing process. In some embodiments, the blower wheel 10 is formed from a polymeric material such as a thermoplastic material. The thermoplastic material may be formed into the shape and configuration of the blower wheel 10 in a suitable injection molding operation, for example. In other embodiments, the blower wheel 10 is formed from a plurality of separately formed components coupled to each other, such as a plurality of metallic components coupled to each other using aggressive coupling methods, as desired.

The blower wheel 10 shown and described in FIGS. 1-3 preferably includes a center of mass thereof disposed on the axis of rotation 1 of the blower wheel 10 (a central axis of the rotor 15) to avoid an imbalance of the blower wheel 10 during rotation thereof. However, as is understood in the art, inconsistencies present in the materials forming the blower wheel 10 or in the manufacturing process used to form the blower wheel 10 may result in an imbalanced condition of the blower wheel 10 relative to the axis of rotation 1 thereof. The imbalanced condition includes a center of mass of the blower wheel 10 taken with respect to at least one plane arranged perpendicular to the axis of rotation 1 of the blower wheel 10 displaced from the axis of rotation 1. For example, an injection molding operation used to form the blower wheel 10 may result in the blower wheel 10 having an inconsistent material density leading to the imbalanced condition. Alternatively, any manufacturing inconsistencies introduced during an alternative manufacturing process may result in the imbalanced condition of the blower wheel 10.

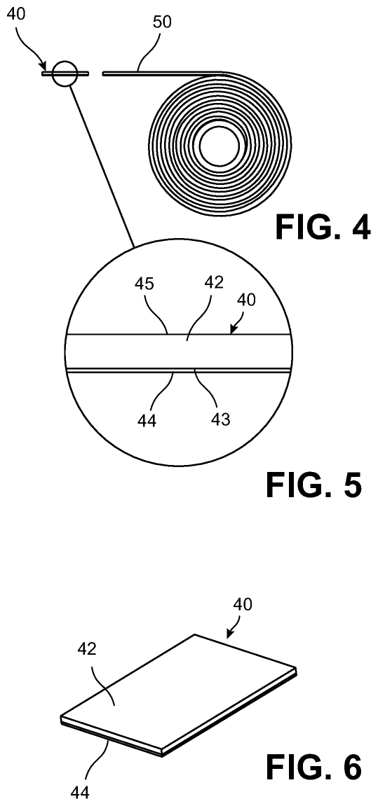

In order to correct the potential imbalance of the blower wheel 10, the blower wheel 10 may optionally include at least one counterweight 40 coupled thereto. As shown in FIGS. 4-6, each of the counterweights 40 includes a base layer 42 having a first major surface 43 thereof coated with a layer of a suitable adhesive 44 and an oppositely arranged second major surface 45 configured to be exposed to the flow of the air passing through the blower wheel 10 during operation of the blower motor assembly 5. Each of the counterweights 40 may accordingly form an adhesive-backed tape suitable for adhering to a portion of an outer surface of the blower wheel 10.

In some embodiments, the base layer 42 may be formed from a polymeric material having a suitable degree of flexibility and compliancy. The flexibility of the base layer 42 may allow each of the counterweights 40 to elastically deform in order to compliantly conform to a shape of the corresponding portion of the outer surface of the blower wheel 10. The polymeric material may include a substantially smooth surface finish to minimize the frictional forces present between the air passing through the blower wheel 10 and the second major surface 45 of each of the counterweights 40.

The polymeric material may be formed as a thin plastic film having the requisite characteristics described above. The plastic film may be formed from a thermoplastic material such as polyethylene, polypropylene, nylon, cellophane, or co-polymers thereof, as non-limiting examples. Alternatively, the polymeric material may be an elastomer, as desired.

In some embodiments, the base layer 42 may be a composite including a blend of constituent materials. The composite may include a blend of at least one polymer and at least one filler, wherein the filler may be added for increasing a density of the composite. The at least one polymer may be any suitable polymer, including an elastomer or a thermoplastic polymer such as a suitable polyolefin. The composite may alternatively be a co-polymer of any two or more of the polymeric materials described herein.

In alternative embodiments, the base layer 42 may be formed from a relatively thin layer of a metallic material suitable for being compliantly deformed to conform to the shape of the portion of the outer surface of the blower wheel 10. The metallic material may be aluminum, steel, or alloys thereof, as non-limiting examples. In contrast to the flexible materials described hereinabove, the counterweights 40 formed from the metallic material may be at least partially plastically deformed when conforming to the shape of the corresponding feature of the blower wheel 10. It should be understood, however, that the metallic material may only be elastically deformed when conforming to the shape of the portion of the blower wheel 10 without departing from the scope of the present invention.

The adhesive 44 may be any suitable adhesive having the strength required for maintaining a position of each of the counterweights 40 on the corresponding one of the blades 12. The adhesive 44 may be a pressure sensitive adhesive (PSA), as desired. The adhesive 44 may be formed from a polymeric material. The adhesive 44 may be configured to set or cure only after contacting the outer surface of the blower wheel 10 for an extended period of time. The delayed curing or setting of the adhesive 44 may allow for each of the counterweights 40 to be selectively repositioned during the initial installation process, as desired. Such repositioning may be necessary when one of the counterweights 40 has been improperly positioned during the initial installation process. The adhesive 44 may be selected to form a bond between the outer surface of the blower wheel 10 and the base layer 42 having a great enough strength to resist a movement or a decoupling of one of the counterweights 40 during rotation of the blower wheel 10, such as when a flow of air passes over the second major surface 45 of each of the counterweights 40 during normal operation of the blower motor assembly 5.

As shown in FIG. 6, each of the counterweights 40 may include a substantially rectangular perimeter shape prior to the coupling of each of the counterweights 40 to a portion of the blower wheel 10. As shown in FIG. 4, the substantially rectangular perimeter shape may be produced by cutting a strip 50 of material having a substantially constant width and a substantially constant height to a desired length, wherein the strip 50 of material includes both the base layer 42 and the adhesive 44. The strip 50 may be presented as an elongate and linear extension of the material or the strip 50 may be presented as a wound roll of the material as depicted in FIG. 4, as desired. In either circumstance, the knowledge of the density of the material forming the strip 50 allows for a mass of each of the counterweights 40 to be selected by cutting and removing a desired length of the strip 50. As such, the cutting or shearing of the strip 50 of material when forming the counterweights 40 beneficially allows for each of the counterweights 40 to be presented at a substantially exact mass value for correcting the aforementioned imbalance experienced by the blower wheel 10.

The use of a substantially compliant base layer 42 allows for each of the counterweights 40 to be shaped to cover or wrap around a plurality of different surface features of the blower wheel 10 for facilitating a variety of possible positions and orientations of the counterweights 40 when correcting the imbalance of the blower wheel 10. More specifically, each of the counterweights 40 is configured to conform to the outer surface of the blower wheel 10 at various features thereof such as the first surface 22, the second surface 24, the leading edge 18, or the trailing edge 20 of each of the blades 12, the inner circumferential surface 3, the outer circumferential surface 4, or any edge of the first ring 16a, the inner circumferential surface 7, the outer circumferential surface 8, or any edge of the second ring 16b, or an inner surface, an outer surface, or any edge of the hub 14. The counterweights 40 may accordingly be coupled to essentially any portion of the outer surface of the blower wheel 10 for correcting the imbalance thereof. The compliancy of each of the counterweights 40 beneficially allows for each of the counterweights 40 to engage the outer surface of the blower wheel 10 with a maximum surface area of the adhesive 44 placed in contact with the outer surface, thereby aiding in securing each of the counterweights 40 to the blower wheel 10. The compliancy of each of the counterweights 40 further reduces a profile of each of the counterweights 40 when coupled to the outer surface of the blower wheel 10, which in turn minimizes any effects the presence of the counterweight 40 may have on the flow of air passing over the counterweight 40, such as undesirably lowering a pressure of the air exiting the blower wheel 10.

It should be understood that the embodiments of the counterweights 40 described as being substantially flexible prior to application to the blower wheel 10 are configured to maintain the deformed shape thereof following the disposition of each of the counterweights 40 on the outer surface of the blower wheel 10 and the adhesion of the base layer 42 to the outer surface of the blower wheel 10 via the adhesive 44. In other words, those embodiments of the counterweights 40 described as being formed from a flexible and elastically deformable material (such as a thin plastic film) may be elastically deformed when applied to the outer surface of the blower wheel 10 while the adhesion of the base layer 42 to the blower wheel 10 via the adhesive 44 maintains the elastically deformed configuration of the counterweight 40 relative to the outer surface of the blower wheel 10. It should also be understood that those embodiments of the counterweights 40 formed from a more rigid material (such as a thin metallic material) will similarly maintain a substantially rigid and inflexible configuration relative to the outer surface of the blower wheel 10 following the adhesion of the base layer 42 to the blower wheel 10 via the adhesive 44, regardless of whether the more rigid material is elastically deformed, plastically deformed, or partially deformed both elastically and plastically.

The material forming the base layer 42 may be selected to include a density great enough for correcting the imbalance of the blower wheel 10 without requiring each of the counterweights 40 to be undesirably large and cumbersome. The material forming the base layer 42 may also be selected based on the operating conditions experienced by the blower motor assembly 5. For example, the material may be selected to include a desired melting temperature or a desired corrosion resistance based on the expected conditions experienced by the blower motor assembly 5 during operation thereof.

A balancing of the blower wheel 10 using at least one of the counterweights 40 may occur as follows. A first step may include determining an imbalance of the blower wheel 10, wherein the imbalance may be expressed in both magnitude and direction. A second step may include determining at least one suitable configuration of at least one of the counterweights 40 on the outer surface of the blower wheel 10 for correcting the imbalance discovered during the first step, wherein the determining of the at least one suitable configuration includes determining a suitable mass and a suitable position for at least one of the counterweights 40 for offsetting the discovered imbalance. A third step may include determining a volume of the corresponding counterweight 40 necessary for adding the desired amount of mass to the blower wheel 10 as determined in the second step. A fourth step may include forming the at least one counterweight 40 at the desired volume and hence the desired mass, wherein the forming step may include removing the at least one counterweight 40 from an elongate strip 50 of material by cutting or a similar shearing process. A fifth step may include disposing the at least one counterweight 40 on the outer surface of the blower wheel 10 at the desired position and adhering the at least counterweight 40 to the outer surface of the blower wheel 10. The first step of determining the imbalance of the blower wheel 10 may then be repeated to determine if the placement of the at least one counterweight 40 corrected the previously discovered imbalance of the blower wheel 10.

The step of determining the imbalance of the blower wheel 10 may be performed using any method known in the art. Typically, the determining step includes mounting the blower motor assembly 5 on a suitable measuring apparatus (not shown). The rotor 15 of the blower motor assembly 5 may be driven by the driving mechanism of the blower motor 11 in order to rotate the blower wheel 10 relative to the motor housing 13 and the measuring apparatus. During the rotation of the blower wheel 10, a plurality of sensors or other measuring devices (not shown) associated with the measuring apparatus measure the dynamic forces experienced by the blower wheel 10. The dynamic forces are measured with respect to at least a first predetermined measuring plane arranged perpendicular to the axis of rotation of the blower wheel 10, and may be performed with respect to two or more independent and axially spaced apart measuring planes, as explained in greater detail hereinafter.

The measuring of the dynamic forces results in the determination of a location of the actual center of mass C of the blower wheel 10 with respect to the first measuring plane. A first vector V₁ extending along the first measuring plane from the axis of rotation 1 of the blower wheel 10 to the center of mass C for the first measuring plane indicates a direction of the imbalance of the blower wheel 10 with respect to the first measuring plane, wherein the direction of imbalance may be expressed by an angle at which the first vector V₁ deviates from a reference axis A disposed on the first measuring plane and originating from the axis of rotation 1 of the blower wheel 10. A distance of the center of mass C from the axis of rotation 1 is directly related to the magnitude of the imbalance, wherein the magnitude of the imbalance is increased as the distance of the center of mass C from the axis of rotation 1 is increased.

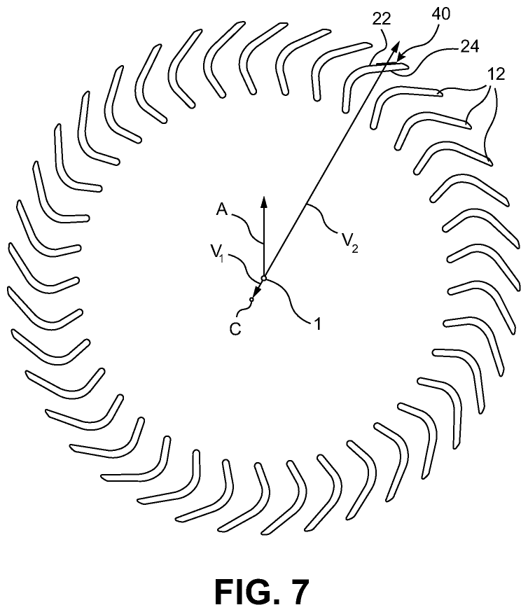

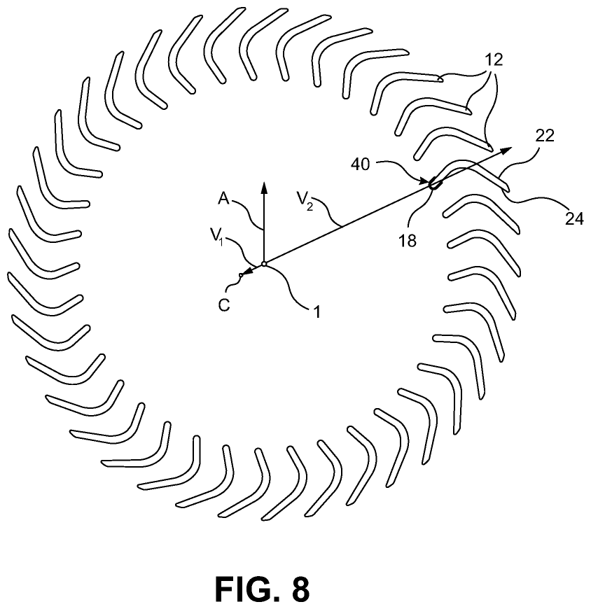

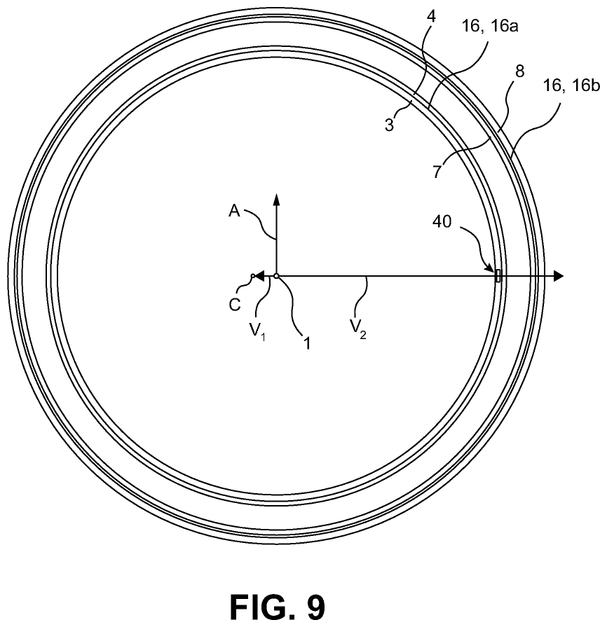

For example, FIG. 7-9 illustrate three different examples of the determination of the center of mass C of the blower wheel 10 relative to the axis of rotation 1 thereof. The examples illustrated by FIGS. 7 and 8 include the first measuring plane taken through a portion of the blower wheel 10 exclusively including the annular array of the blades 12, hence the hub 14 and the rings 16a, 16b are removed from FIGS. 7 and 8 for simplicity and clarity. Similarly, the example illustrated by FIG. 9 includes the first measuring plane taken through a portion of the blower wheel 10 including only the rings 16a, 16b, hence the blades 12 and the hub 14 have been removed from FIG. 9 for simplicity and clarity. It should further be understood that each of the illustrated examples includes an exaggerated distance of the center of mass C from the axis of rotation 1 in order to more easily show and describe the features of the present invention. Each of the illustrated examples may represent the only measuring plane tested during a single plane testing process or each of the illustrated examples may represent one of multiple measuring planes tested during a multiple plane testing process without departing from the scope of the present invention.

In each of the provided examples, the reference axis A extends vertically upward from the axis of rotation 1 of the blower wheel 10 as shown from the perspective of FIGS. 7-9. Based on the orientation of the reference axis A, the direction of imbalance of the center of mass C as shown in FIG. 7 is about 210 degrees, the direction of imbalance of the center of mass C as shown in FIG. 8 is about 245 degrees, and the direction of imbalance of the center of mass C as shown in FIG. 9 is about 270 degrees. In each case, the first vector V₁ extending from the axis of rotation 1 to the corresponding center of mass C represents the direction of the imbalance of the blower wheel 10 while a length of the first vector V₁ is also proportional to the magnitude of the imbalance in the indicated direction.

With continued reference to FIGS. 7-9, following the determination of the magnitude and angle of the imbalance for each tested measuring plane, the second step of determining at least one suitable configuration of at least one of the counterweights 40 on the outer surface of the blower wheel 10 is performed. A second vector V₂ extending from the axis of rotation 1 in a direction opposite the first vector V₁ determines the possible locations for positioning one of the counterweights 40 for correcting the imbalance with respect to each of the illustrated measuring planes.

For example, in FIG. 7 the second vector V₂ passes through each of the first surface 22 and the second surface 24 of one of the blades 12, thereby indicating that one of the counterweights 40 may be coupled to either or both of the surfaces 22, 24 of the blade 12 without frustrating the disclosed balancing process. As should be understood, the necessary mass of the counterweight 40 used for correcting the determined imbalance of the blower wheel is dependent on both the magnitude of the imbalance as well as the distance the counterweight 40 is spaced from the axis of rotation of the blower wheel 10, wherein the mass required to correct the determined imbalance is reduced the further the counterweight 40 is spaced from the axis of rotation 1. The mass of the selected counterweight 40 may accordingly be dependent on the selection of the desired position for the counterweight 40 among the possible positions indicated by the second vector V₂. In the example shown in FIG. 7, the counterweight 40 is shown as being adhered to the convex first surface 22 of the blower wheel 10, as one non-limiting configuration.

In FIG. 8, the second vector V₂ passes through each of the leading edge 18, the first surface 22, and the second surface 24 of one of the blades 12, hence the counterweight 40 may be coupled to any of the aforementioned features for correcting the imbalance of the blower wheel 10. In the given example, the counterweight 40 is shown as being adhered to the leading edge 18 of the one of the blades 12 as one non-limiting configuration, wherein the counterweight 40 extends around a convex surface formed by the leading edge 18 to reduce the profile of the counterweight 40.

In FIG. 9, the second vector V2 always passes through each of the rings 16a, 16b, hence one of the counterweights 40 may be coupled to any of the inner circumferential surface 3 of the first ring 16a, the outer circumferential surface 4 of the first ring 16a, the inner circumferential surface 7 of the second ring 16b, the outer circumferential surface 8 of the second ring 16b, or any edges formed by either of the first ring 16a or the second ring 16b. In the given example, the counterweight 40 is shown as being coupled to the inner circumferential surface 3 of the first ring 16a as one non-limiting configuration.

Once the desired position for the counterweight 40 is determined for each given example, a volume and hence a mass of the corresponding counterweight 40 is selected according to the third step in order to offset the imbalance of the blower wheel 10. As previously described, a desired mass for each of the counterweights 40 may be selected by cutting or otherwise shearing the strip 50 of the material used to form each of the counterweights 40 at a desired location during application of the fourth step with the width and height directions of the strip 50 of material remaining constant, thereby resulting in a counterweight 40 having a substantially rectangular perimeter shape with a known mass.

The fifth step includes placing the first major surface 43 of the corresponding counterweight 40 having the adhesive 44 coated thereon in facing relationship with the portion of the outer surface of the blower wheel 10 intersected by the second vector V₂ with respect to each given example. The counterweight 40 is then pressed toward the corresponding surface to allow for the counterweight 40 to substantially conform to the shape of the corresponding surface to maximize the amount of the first major surface 43 having the adhesive 44 placed in contact with the outer surface of the blower wheel 10. If a pressure sensitive adhesive is used, the pressing of the counterweight 40 may occur at a desired pressure or for a desired period of time to ensure that the counterweight 40 is securely coupled to the corresponding surface. The pressing step may include a soft pad or similar structure used to apply the pressure without damaging a portion of the counterweight 40 or the blower wheel 10, as desired.

The disclosed balancing process has thus far been discussed relative to a single first measuring plane, but it is typically desirable to perform the disclosed balancing process with respect to at least two parallel arranged measuring planes to more effectively balance the blower wheel 10. Furthermore, it has been discovered that the balancing process is typically more efficient and precise when the two balancing planes are spaced from each other as far as possible with respect to an axial direction of the blower wheel 10. The use of the adhesive backed counterweights 40 beneficially allows for the operator performing the balancing process to select two maximally spaced measuring planes due to the manner in which each of the counterweights 40 can be conformed and adhered to essentially any portion of the outer surface of the blower wheel 10. For example, although not pictured in FIGS. 7-9, the counterweights 40 may additionally be coupled to the hub 14 at desired locations in accordance with the general concepts disclosed herein. More generally, it should be understood that any annularly extending structure of the blower wheel 10 suitable for connecting each of the blades 12 thereof may be suitable for receiving one of the counterweights 40 in addition to those annular structures shown and described in reference to the blower wheel 10 depicted in FIGS. 1-3.

The disclosed balancing process may result in the operator adding one or more of the counterweights 40 to the blower wheel 10 depending on the number of balancing planes analyzed and the amount of imbalance detected for each of the analyzed balancing planes. For example, if the magnitude of the imbalance is relatively large with respect to each of two balancing planes, then one of the counterweights 40 may be added to the blower wheel 10 for each of the analyzed balancing planes. Under other circumstances, such as when the magnitude of imbalance for each of the analyzed planes is relatively small, one of the counterweights 40 may only be added to the blower wheel 10 with respect to the balancing plane having the greater magnitude of imbalance. Each of the counterweights 40 is also typically disposed on the outer surface of the blower wheel 10 at a position wherein the associated balancing plane passes therethrough. However, one skilled in the art should appreciate that the balancing process may include placing one or more of the counterweights 40 at positions intermediate or spaced from the measured balancing planes, as desired, without departing from the scope of the present invention.

As set forth throughout, the use of the adhesive backed and compliant counterweights greatly expands the number of possible positions for the counterweights by eliminating the requirement that the counterweight be coupled to an exposed edge of the blower wheel. The counterweights can also be advantageously formed to include an exact mass value by simply cutting a desired length of a strip of material forming each of the counterweights by virtue of knowing the mass per unit length of the strip of the material. The ability to produce one of the counterweights at a desired mass value and the ability to place one of the counterweights at a desired location on the blower wheel leads to a circumstance wherein the imbalance of each associated measuring plane may be resolved by installation of a single one of the counterweights in a single iteration. The use of an adhesive also lessens a profile of each of the counterweights when adhered to the blower wheel, which in turn reduces any negative affects the counterweights could have on the flow of air passing through the blower wheel.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. A blower wheel comprising:
a plurality of annularly arranged blades;
an annular structure coupled to each of the blades; and
a counterweight adhered to the blower wheel, the counterweight including a base layer having an adhesive coated thereon, wherein the counterweight is configured to correct an imbalance of the blower wheel relative to an axis of rotation of the blower wheel.

2. The blower wheel of claim 1, wherein the base layer is formed from a polymeric material.

3. The blower wheel of claim 1, wherein the base layer is formed from a metallic material.

4. The blower wheel of claim 1, wherein the base layer conforms to a shape of an outer surface of the blower wheel.

5. The blower wheel of claim 1, wherein the counterweight is adhered to one of the blades.

6. The blower wheel of claim 5, wherein each of the blades includes a leading edge, a trailing edge, a first surface connecting the leading edge to the trailing edge, and a second surface arranged opposite the first surface and connecting the leading edge to the trailing edge, wherein the counterweight is adhered to one of the leading edge or the trailing edge of one of the blades.

7. The blower wheel of claim 5, wherein each of the blades includes a leading edge, a trailing edge, a first surface connecting the leading edge to the trailing edge, and a second surface arranged opposite the first surface and connecting the leading edge to the trailing edge, wherein the counterweight is adhered to one of the first surface or the second surface of one of the blades.

8. The blower wheel of claim 1, wherein the counterweight is adhered to the annular structure.

9. The blower wheel of claim 8, wherein the annular structure includes an inner circumferential surface and an outer circumferential surface, wherein the counterweight is adhered to one of the inner circumferential surface or the outer circumferential surface of the annular structure.

10. A method of balancing a blower wheel of a blower motor assembly, the method comprising the steps of:
determining an imbalance of the blower wheel relative to a rotational axis thereof; and
adhering a counterweight to the blower wheel to correct the imbalance of the blower wheel.

11. The method of claim 10, wherein the determining step includes determining a position of a center of mass of the blower wheel, and wherein the adhering step includes adhering the counterweight to a portion of the outer surface of the blower wheel diametrically opposed to the center of mass with respect to an axis of rotation of the blower wheel.

12. The method of claim 10, further including a step of forming the counterweight by cutting a strip of material to a desired length corresponding to a desired mass of the counterweight.

13. The method of claim 12, wherein the strip of material has a preselected height, a preselected width, and preselected density.

14. The method of claim 12, wherein the strip of material includes a base layer having an adhesive coated thereon.

15. The method of claim 15, wherein the base layer is formed from a polymeric material.

16. The method of claim 15, wherein the base layer is formed from a metallic material.

17. The method of claim 10, wherein the blower wheel includes a plurality of annularly arranged blades and an annular structure coupled to each of the blades.

18. The method of claim 17, wherein each of the blades includes includes a leading edge, a trailing edge, a first surface connecting the leading edge to the trailing edge, and a second surface arranged opposite the first surface and connecting the leading edge to the trailing edge, wherein the counterweight is adhered to one of the leading edge or the trailing edge of one of the blades.

19. The method of claim 17, wherein each of the blades includes includes a leading edge, a trailing edge, a first surface connecting the leading edge to the trailing edge, and a second surface arranged opposite the first surface and connecting the leading edge to the trailing edge, wherein the counterweight is adhered to one of the first surface or the second surface of one of the blades.

20. The method of claim 17, wherein the annular structure includes an inner circumferential surface and an outer circumferential surface, wherein the counterweight is adhered to one of the inner circumferential surface or the outer circumferential surface of the annular structure.
